(19) United States
(12) Patent Application Publication
(10) Pub. No.: US 2023/0071362 A1
(43) Pub. Date: Mar. 9, 2023

(54) GENERATING EXPLANATIONS FOR AN AGGREGATED ASSISTANT'S ACTIONS

(71) Applicant: INTERNATIONAL BUSINESS MACHINES CORPORATION, Armonk, NY (US)

(72) Inventors: Sarath Sreedharan, Tempe, AZ (US); Tathagata Chakraborti, Cambridge, MA (US); Yara Rizk, Cambridge, MA (US); Vinod Muthusamy, Austin, TX (US); Yasaman Khazaeni, Needham, MA (US)

(21) Appl. No.: 17/469,852

(22) Filed: Sep. 8, 2021

(51) Int. Cl. G06N 5/02; G06F 16/903

(52) U.S. Cl. CPC G06N 5/02; G06F 16/90335

(57) ABSTRACT

A computer-implemented method of generating explanations for a sequence of actions performed by an aggregated assistant includes receiving a request from a user equipment (UE) to execute a sequence of actions. A decision is rendered on whether to execute the requested sequence of actions. An explanation regarding the rendered decision is provided including a user data upon which the decision is based.

### STATEMENT REGARDING PRIOR DISCLOSURES BY THE INVENTOR OR A JOINT INVENTOR

Sreedharan, S. et al., “Explainable Composition of Aggregated Assistants,” Nov. 21, 2020, available at https://arxiv.org/abs/2011.10707.

### BACKGROUND

### Technical Field

The present disclosure generally relates to systems and methods of operating aggregated assistants, and more particularly, to a computer-implemented method and system of generating explanations for actions performed by an aggregated assistant.

### Description of the Related Art

Advances in Artificial Intelligence (AI) with regard to skilled AI assistants has become increasingly popular. More particularly, an “aggregated assistant” is typically generated as an orchestrated composition of several individual skills or agents that can each perform atomic tasks. Aggregated assistants are increasing in popularity to provide users with services at any hour of the day.

### SUMMARY

In one embodiment, a computer-implemented method of generating explanations for actions performed by an automated assistant. A request is received from a user equipment (UE) to execute a sequence of actions, and a decision is rendered on whether to perform the requested sequence of actions. An explanation regarding the rendered decision is provided including identification of a user data upon which the decision is based.

In an embodiment, the computer-implemented method further includes reducing a computational burden on the automated assistant by outputting the identification of the user data without receiving a request from the UE for the identification of the user data, and wherein the explanation includes information about why a particular portion of the user data was used with regard to the rendered decision to execute the sequence of actions.

In an embodiment, the explanation includes information about how a particular portion of the user data was used to render the decision to execute the sequence of actions, including whether the user data was shared with another entity, and the explanation includes information about how a particular portion of the user data is going to be used with the other entity to render the decision to execute the sequence of actions, and why a particular portion of the user data is going to be used to render the decision to execute the sequence of actions.

In an embodiment, the automated assistant is an aggregated assistant including a plurality of skills and one or more agents, and the computer-implemented method further includes receiving a query for the provenance of the user data to render the decision to execute the sequence of actions; and generating a summary explanation about the provenance of the user data used to render the decision to execute the sequence of action.

In an embodiment, the summary explanation to render the decision to execute the sequence of actions is generated by using an explainability model.

In an embodiment, the summary explanation is configured as a summary of landmarks to be drilled down recursively.

In an embodiment, the summary explanation includes information indicating how a particular portion of the user data is used to render the decision to execute the sequence of actions.

In an embodiment, the summary explanation includes information about why a particular portion of the user data was used to render the decision to execute the sequence of actions.

In an embodiment, in response to the received query for provenance, the summary explanation includes an identification of any other entities with which the user data is going to be shared, and the summary explanation includes information about how a particular portion of the user data is going to be used with the other entity to render the decision to execute the sequence of actions, and why a particular portion of the user data is going to be used to render the decision to execute the sequence of actions.

In one embodiment, a computing device is configured to generate explanations for actions of an aggregated assistant, the computing device includes a processor; a memory coupled to the processor. The memory stores instructions to cause the processor to perform acts including receiving a request to perform a sequence of actions, rendering a decision on whether to perform the requested sequence of actions, and providing an explanation to render the decision to perform the sequence of actions including a user data upon which the rendered decision is based.

In an embodiment, the instructions cause the processor to perform additional acts of receiving a query for the provenance of the user data to render the decision whether to perform the requested sequence of actions, and providing a response explaining the provenance of the user data used to render the decision.

In an embodiment, the instructions cause the processor to perform additional acts of reducing the computational burden of the processor by generating the summary explanation about the provenance of the user data used to render the decision to perform the sequence of actions without receiving a request regarding the provenance of the user data; and using an explainability model to generate the summary explanation.

In an embodiment, a non-transitory computer-readable storage medium tangibly embodying a computer-readable program code having computer-readable instructions that, when executed, causes a computer device to perform a method of generating explanations for actions of an aggregated assistant, the method includes receiving a request to perform a sequence of actions. A decision is rendered whether to perform the requested sequence of actions. An explanation is provided regarding the rendered decision that includes identifying a user data upon which the rendered decision is based.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 is an overview of the operations of a computer-implemented method of generating explanations for actions performed by an aggregated assistant, consistent with an illustrative embodiment.

FIG. 2 is an illustration of the operation of an assistant, consistent with an illustrative embodiment.

FIG. 3A illustrates a compilation of an aggregated assistant's skills, consistent with an illustrative embodiment.

FIG. 3B is an illustration of computer hardware associated with the aggregated assistant's skills shown in FIG. 3A, consistent with an illustrative embodiment.

FIG. 4 illustrates an operation of a “how” question, consistent with an illustrative embodiment.

FIG. 5 illustrates an operation of a “why” question, consistent with an illustrative embodiment.

FIG. 6 illustrates an example of an assistant's explanation of the decision chains, consistent with an illustrative embodiment.

FIG. 7A illustrates a resource request operation, consistent with an illustrative embodiment.

FIG. 7B illustrates an example of the skills aggregation used in the resource request operation of FIG. 7A, consistent with an illustrative embodiment.

FIG. 8 is a flowchart illustrating a non-exhaustive example of a computer-implemented method, consistent with an illustrative embodiment.

FIG. 9 is a functional block diagram illustration of a particularly configured computer hardware platform, consistent with an illustrative embodiment.

FIG. 10 depicts an illustrative cloud computing environment, consistent with an illustrative embodiment.

FIG. 11 depicts a set of functional abstraction layers provided by a cloud computing environment, consistent with an illustrative embodiment.

### DETAILED DESCRIPTION

### Overview

In the following detailed description, numerous specific details are set forth by way of examples to provide a thorough understanding of the relevant teachings. However, it should be understood that the present teachings may be practiced without such details. In other instances, well-known methods, procedures, components, and/or circuitry have been described at a relatively high level, without detail, to avoid unnecessarily obscuring aspects of the present teachings.

It is to be understood that the term “atomic tasks” as used herein generally refers to tasks that can be nm completely independent of other tasks. In general, atomic tasks are not broken down to a finer level of a process model.

A goal as referred to herein is to be considered a metric, including but not in any way limited to, key performance indicators (KPIs). Goals may be extracted from a user communication, such as a text, utterance, etc.

An agent performs actions autonomously and continuously on behalf of an entity. An agent defines at least two functions that may include a preview function and an execution function. An agent specification, which includes a set of skills, may be converted into a planning model to execute functions in response to requests.

An assistant is set up to handle and respond to various types of phenomenon that include but are not limited to texts, utterances, alerts, data objects, and pointers that are generally referred to as events. It is to be understood that the term “aggregated assistant” as used herein generally refers to a type of architecture in which an assistant, including but not limited to a conversational assistant, is built out of individual components called skills. Skills are a unit of automation that perform atomic tasks.

Aggregated assistants have varied degrees of complexity that are often based on a number and/or type of skills. Aggregated assistants can be created “on the fly” based on a set of skills that are based on interactions with an end-user. The orchestration of an aggregated assistant is developed to model different types of assistants and describe the role of planning in it. For example, a flow of the control between an orchestrator and its agents using different orchestration patterns.

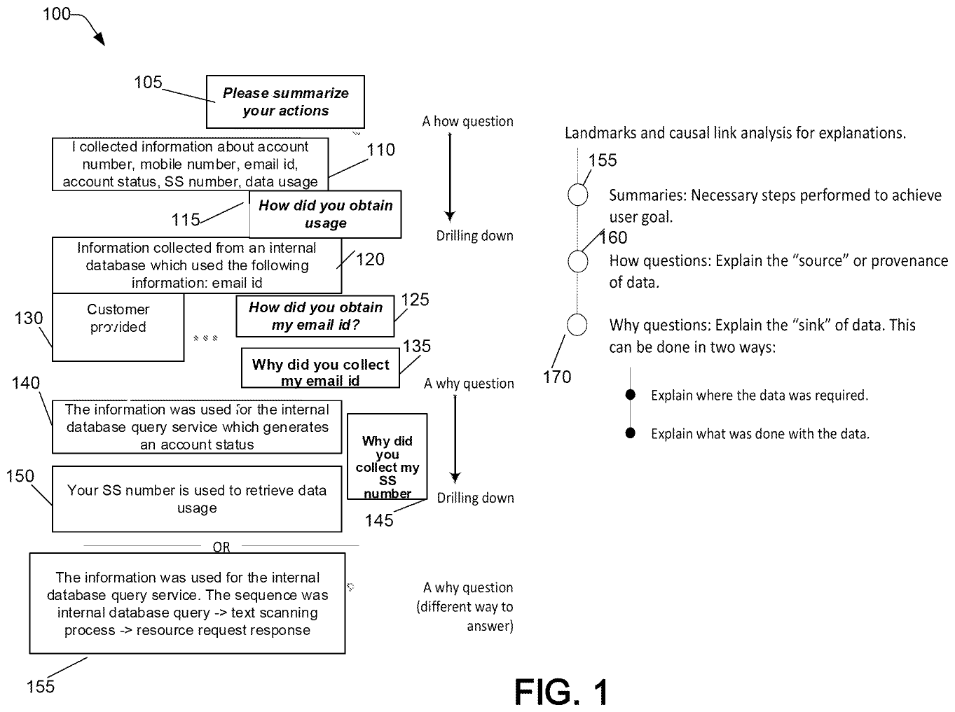

FIG. 1 is an overview 100 of the operations of a computer-implemented method of generating explanations for actions performed by an aggregated assistant, consistent with an illustrative embodiment. It is to be understood that the present disclosure is not limited to the depictions in the drawings, as there may be fewer elements or more elements than shown and described. The boxes in boldface 105, 110, 115, 125, 135, and 145 are communications received by the assistant sent from a computing device including but not in any way limited to a smartphone, tablet, desktop, smartwatch, notebook, vehicle, etc., and the responses shown are generated by the aggregated assistant, consistent with this illustrative embodiment.

The subject matter in this particular illustrative embodiment is related to computer resources. For example, there is a request for an increase in the allotted data usage for a device. Whereas a known aggregated assistant does not provide transparency to an end-user, the computer-implemented method can provide information about the operations to be performed before, during, or after such operations are performed. In addition, the aggregated assistant is also configured to be questioned regarding the course of actions. In this illustrative embodiment, the assistant is being questioned after such actions are performed.

Referring to FIG. 1, at operation 105, a question “please summarize your actions” is received. This question is considered a “how” question (e.g., how did you perform the requested task?). The aggregated assistant responds at 110 that information was collected about an account number, email id, account status, and a Social Security (SS) number (or at least the last four digits of the SS number), and data usage. At 115, there is a “drilling down” to obtain more detail. For example, the aggregate assistant is asked a question “How did you obtain usage?”. At 120, there is a response that the information was collected from an internal database, which used an email address (e.g., email id) as a way to verify the user.

At 125, a follow-up is received in which the assistant receives a question “how did you obtain my email id?”. The response at 130 is that the “customer provided” this information.

FIG. 1 also shows at 135 when a “why question” is received “Why did you collect my email id”. At 140, the aggregated assistant responds that the information was used (or alternatively, is going to be used) for the internal database query service, which generates an account status. Another “drilling down” type question is received at 145 regarding why did you collect my SS number? The explanation generated at 150 is that the SS number is used to retrieve data usage.

A different way to respond to a received “why question” is shown at 155. The explanation is that the information was used for the internal database query service. The sequence of operations was an internal database query, text scanning process, resource request-response. This type of response provides more information about the process than the responses discussed hereinabove.

With further reference to FIG. 1, it is noted that landmarks and causal link analysis can be used for explanations. Thus, the architecture of the computer implemented method can include summaries 155 (e.g., operations performed to achieve a user goal.) “How” questions 160 explain the source of the provenance of data. “Why” questions 170 explain the content of the data received by a data sink. The explanation of the sink of data can be done by explaining where the data was required, and/or explaining what was done with the data. Thus, there is transparency provided both to the end-user and a developer by the computer-implemented method according to the illustrative embodiment.

By virtue of the teachings herein, the computer-implemented method of the present disclosure provides an improvement in computer operations and in computer-implemented decision making using aggregated assistants. For example, the computer-implemented method of the present disclosure improves a transparency of the operations of an aggregated assistant to an end-user, who may question the privacy and security of providing responses to prompts from the aggregated assistant. For example, by making the inner workings of aggregated agents transparent, there is a reduced reluctance to provide requested information, which in turn causes the assistant(s) to generate more accurate responses to received queries. The transparency is also assistive to developers to facilitate debugging operations of the aggregated assistant. In an illustrative embodiment, the computer-implemented method also reduces a computational burden and computing time on the automated assistant by outputting the identification of the user data without receiving a request from the UE for the identification of the user data. The pre-emptive identification of the user data reduces the sequence of interactions between a user equipment and the automated assistant. The computer-implemented method of the present disclosure improves computer operations because the increased transparency leads to fewer iterations, decreased processing overhead, decreased storage needs, and less power consumed.

Additional advantages of the computer-implemented method and device of the present disclosure are disclosed herein.

### Example Embodiments

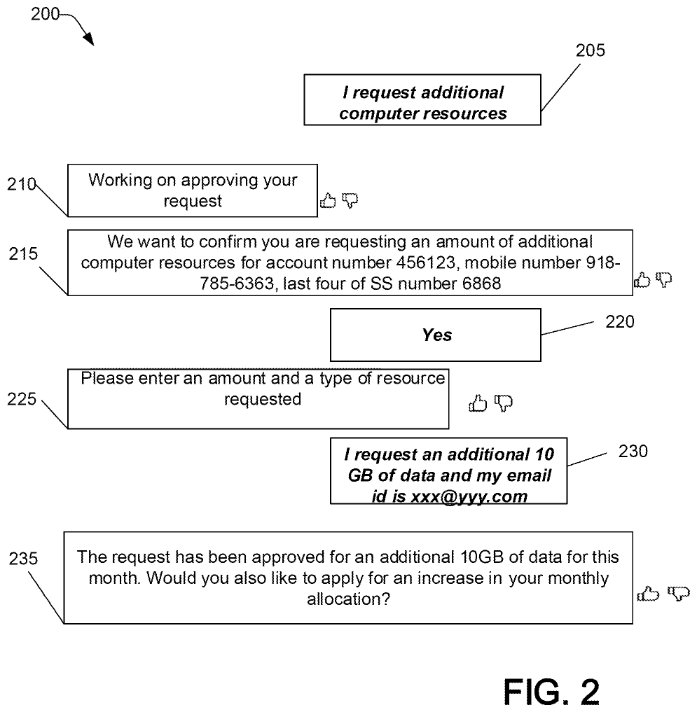

FIG. 2 is an illustration 200 of the operation of an assistant, consistent with an illustrative embodiment. An assistant, such as an aggregated assistant, responds to a request for additional computer resources. It is to be understood that information received by the aggregated assistant can be provided from a device configured to make such requests, or from an end-user. The communications received by the aggregated assistant are displaced in boldface. For example, at operation 205 a request for additional computer resources is received by the aggregated assistant. At operation 210, the aggregated assistant acknowledges that it is working on approving the request for additional resources. At operation 215, there is a request for confirmation that the end-user wants additional resources, as well as a request for confirmation of the end-user's account number, mobile number, and last four digits of the SS number associated with the account number. At operation 220, the requested confirmation is received by the aggregated assistant.

At operation 225, the aggregated assistant prompts for an amount and a type of resource requested. The aggregated assistant receives a response that 10 GB of data is requested (230). The assistant also receives an email id of the entity requesting additional resources. At 235, the aggregated assistant indicates that the request for 10 GB of data is approved for this month, and prompts whether an application for an increase in the monthly allocation of data is requested. In a non-limiting example, a device such as a smartphone could be running low on data and the aggregated assistant approved an additional 10 GB, with the follow-up (basically determining whether this is a one-time request, or a request to increase the data allotment for each month).

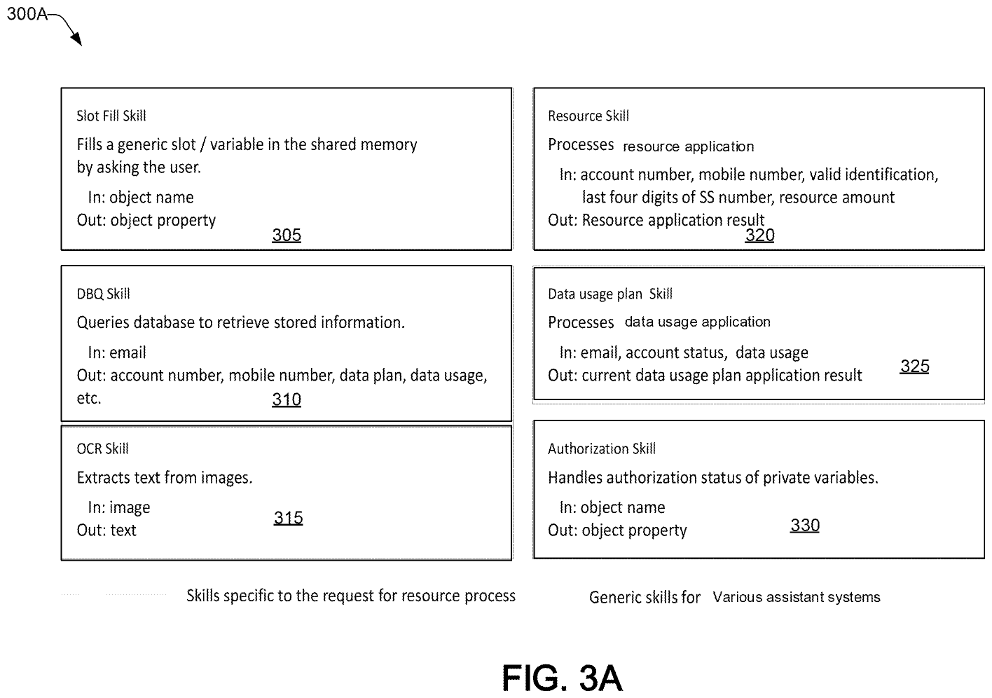

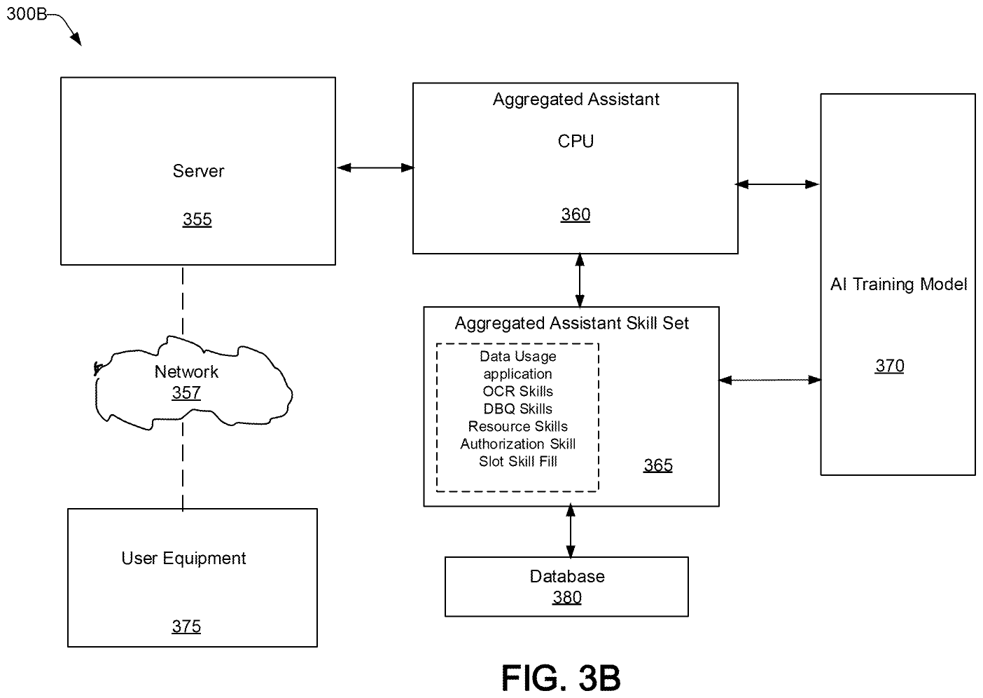

FIG. 3A illustrates a compilation 300A of an aggregated assistant's skills, consistent with an illustrative embodiment. As discussed hereinabove, it is noted that an assistant is built out of individual components called skills. Skills are a unit of automation that perform atomic tasks. It is to be understood that the skills shown in FIG. 3A are provided for illustrative purposes. In practice, there may be more skills, fewer skills, and/or different skills than shown and described. A slot fill skill 305 is configured to fill a generic slot/variable in a shared memory based on asking the user. The Database query (DBQ) skill 310 is configured to retrieve stored information. In this example, the input is an email, and the output is an associated account number, mobile number, data plan information, and/or data usage information. To perform a function related to the skills shown in FIG. 3A, one or more of the skills shown is executed.

The Optical Character Recognition (OCR) skill 315 is configured to extract text from images. An image is input and the output is the extracted text. The Resource Skill is constructed to process resource applications and determine a resource application result (approval, denial, specific resources allotted, etc.). A data usage plan skill 325 processes a data usage application. An input may include, for example, email address, account status, data usage. The output is a current data usage plan application result. An authorization skill 330 handles the authorization of private variables. An example of an input is an object name, and an example of the output is the object property.

FIG. 3B is an illustration of computer hardware 300B associated with operation of the aggregated assistant's skills shown in FIG. 3A, consistent with an illustrative embodiment. It is to be understood that FIG. 3A is provided for illustrative purposes, and the appended claims are not limited to operation based on the components shown and described herein.

The Aggregated assistant 360 communicates through a server 355 (or other computer hardware having an interface) with User Equipment (UE) 375 via a network 357. The communication is typically via the Internet, but it is within the scope of the present disclosure that there can be a wired or wireless connection between the server 355 and UE 375, for example, via WiFi, WiBro, a cellular network, etc. The aggregated Assistant 360 includes a CPU and/or a GPU configured for operation. For example, AI training model 370 provides training data with labels for supervised learning. The aggregated Assistant 360 is configured with one or more skill sets from Aggregated Assistant Skill Set Module 365 that are executed during a session with the UE 375. During the course of a session with the UE 357, the aggregated Assistant 360 may access one or more databases directly, such as database 380, or remotely via the server 355.

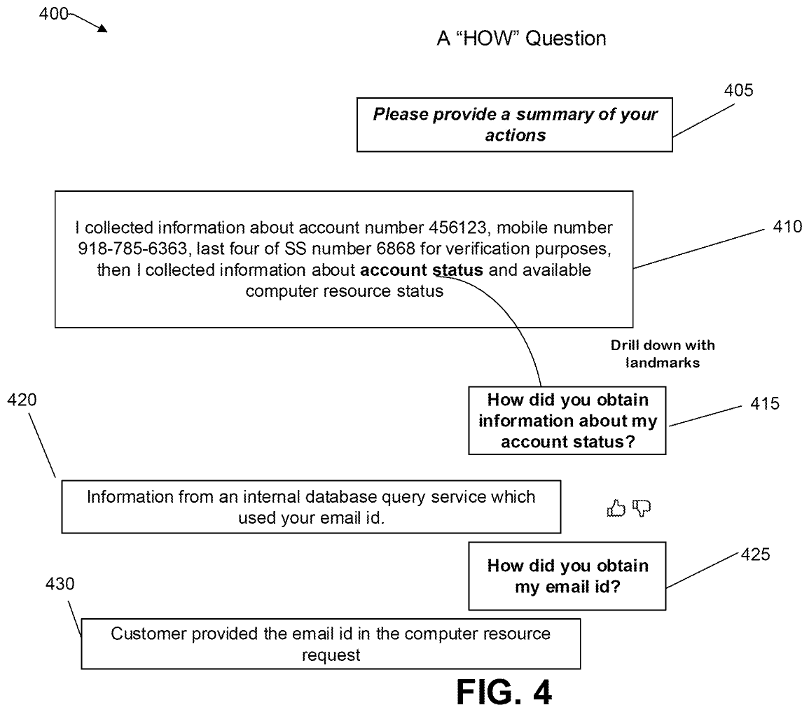

FIG. 4 illustrates an operation of a “how” question 400, consistent with an illustrative embodiment. In this embodiment, the aggregated assistant summarizes using landmarks, then drills down using the causal chain to achieve them. At operation 405, the assistant receives a request for a summary of actions regarding a task. At operation 410, the aggregated assistant responds that information was collected regarding the account number and mobile number. In addition, the last four digits of the SS number were collected for verification purposes. Once a summary is provided, the user is allowed to drill down on any aspect by asking how that aspect was achieved. The agent or skill is identified that provided a portion of the summary, and that agent or skill is used to provide detail to the end-user.

The aggregated assistant also discloses that information was collected about the account status of the end-user and the computer resources available for allocation to the end-user. At operation 415, it is shown that there is a drill down with regard to the account status. For example, the aggregated assistant receives an inquiry regarding how information was obtained about the end-user's account status. At operation 420, the aggregated assistant responds that account status was obtained by information from an internal database query service that used the end-user's email id. The aggregated assistant then receives an inquiry regarding how the email id was obtained. At operation 430, the aggregated assistant responds that the customer provided the email id in the computer resource request.

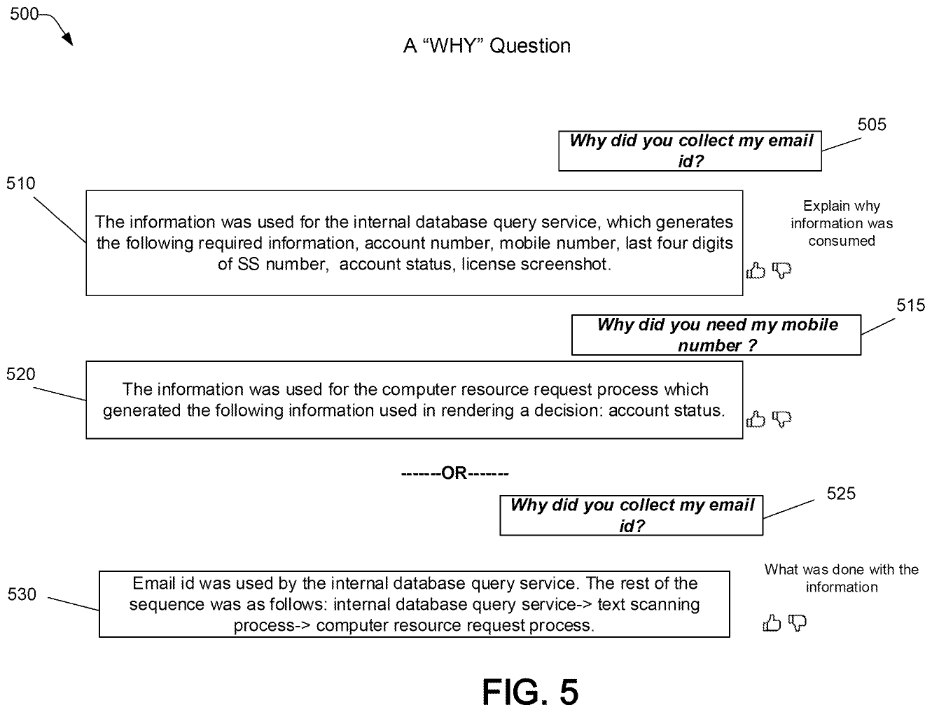

FIG. 5 illustrates an operation of a “why” question 500 consistent with an illustrative embodiment. The aggregated assistant responds to why the outputs of an event was consumed recursively OR what actions were taken based on that event. At operation 505, the assistant receives an inquiry with regard to why an end-user's email was collected. At 510, the assistant responds that the email id was used for the internal database query service, which generated information including the account number, mobile number, last four digits of the SS number, account status, and a license screenshot. It is to be understood that the aforementioned information is provided for illustrative purposes and there is no requirement to use a particular type of information. At 515, the assistant receives an inquiry as to why the end-user's mobile number was needed. At 520, the assistant responds that the information was used for verification purposes regarding the compute resource request process. There is an additional disclosure that the computer resource request process used the information in rendering a decision regarding account status.

An alternative response to the “why” question is also shown in FIG. 5. At 525, the question “why did you collect my email id?” is received by the aggregated assistant. At operation 530, the aggregated assistant responds that the email information was used by the internal database query service. Then the sequence information is provided, with the aggregated assistant remarking that after the internal database query service, the sequence including a text scanning process, and a computer resource request.

With further regard to a “why” question, the user can ask why certain actions were performed. A user may explore the reason(s) why something was used to achieve a goal. A full causal chain can be provided as to why the information was used to achieve a goal. Alternatively, a final action regarding the actions taken (without the full causal chain) can be provided in response to receiving such “why” questions. It is noted that the individual agents and skill may be using Artificial Intelligence (AI) components to generate decisions and an explanation for such decisions can be provided by an agent or the skill itself.

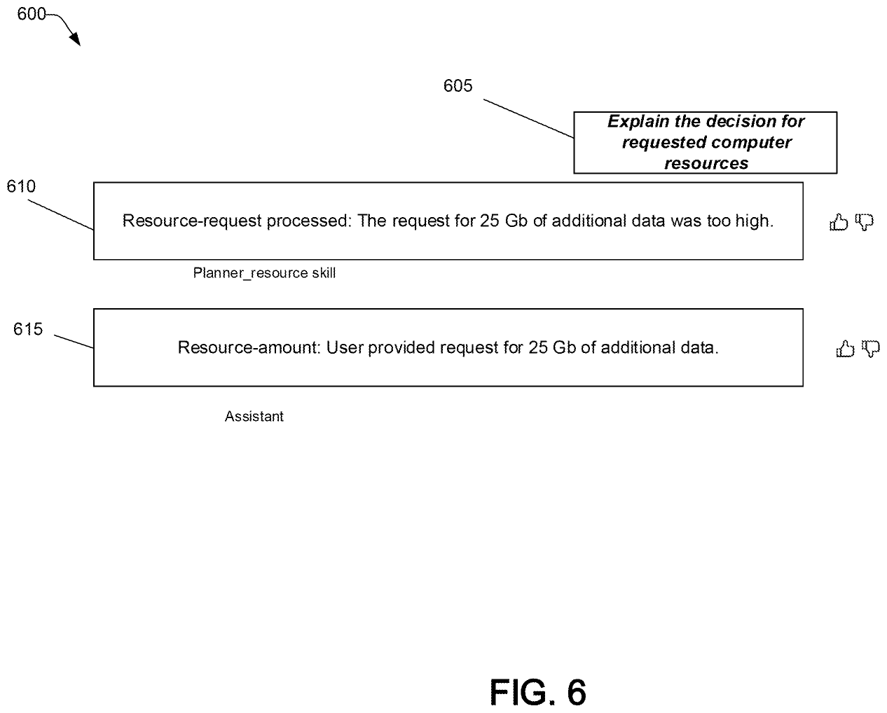

FIG. 6 illustrates an example of an assistant's explanation 600 of decision chains, consistent with an illustrative embodiment. At operation 605, there is a received request to explain the decision for computer resources. At 610 the assistant responds that the resource request was processed and that the request for 25 Gb of additional data was too high. This response is generated by a resource skill 320, such as shown in FIG. 3. At 615, the assistant indicates that the end-user provided a request for 25 Gb of additional data.

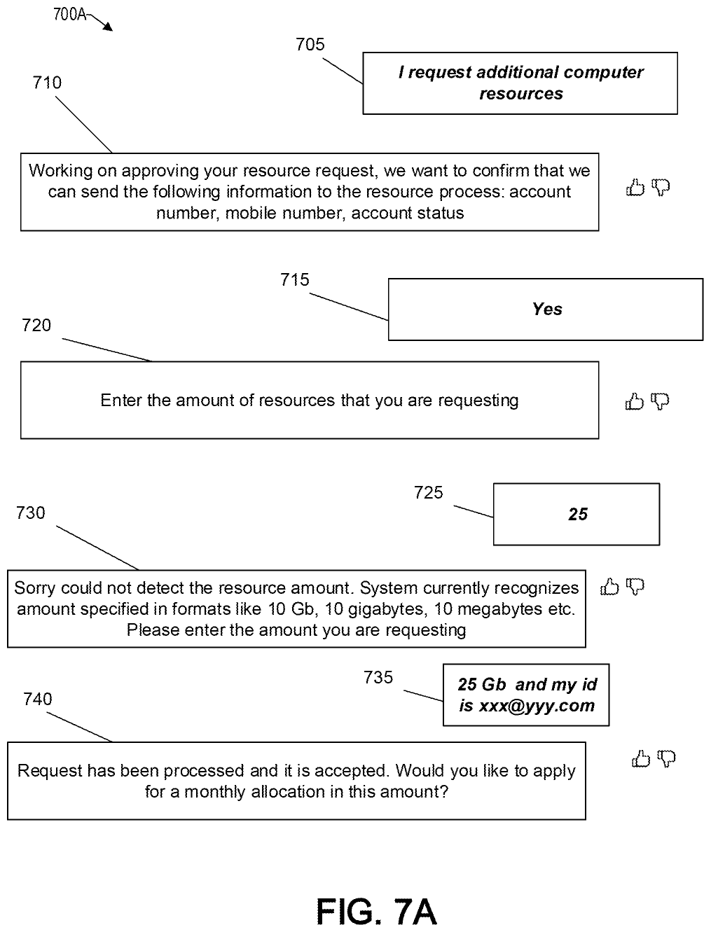

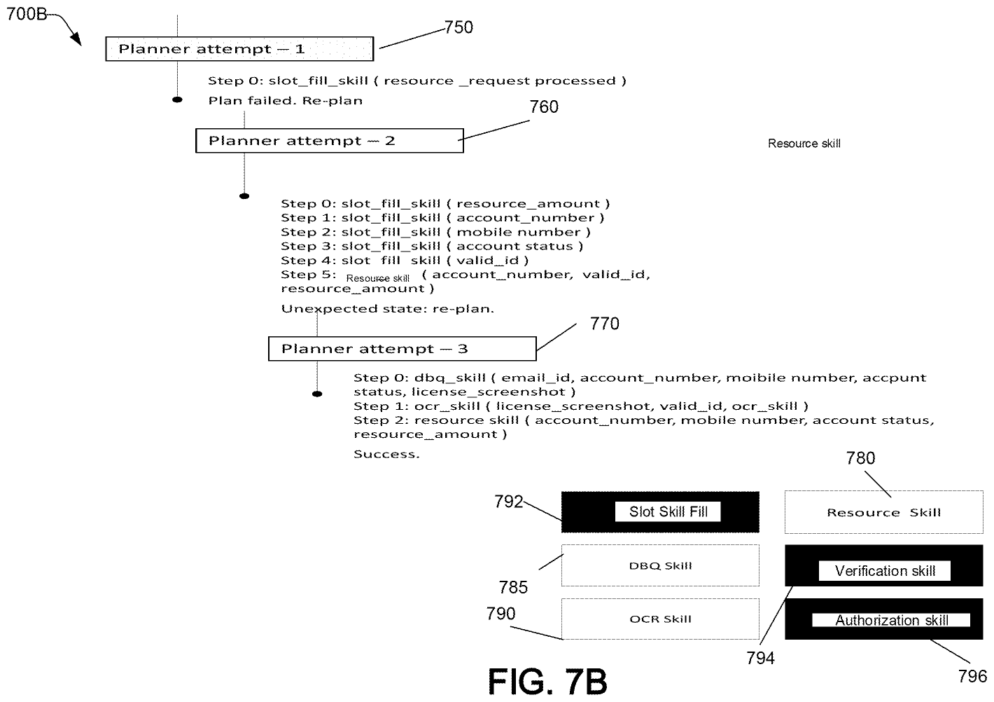

FIG. 7A illustrates a resource request operation 700A, consistent with an illustrative embodiment. At operation 705, a request for additional computer resources is received. At operation 710, the aggregated assistant first confirms whether permission is granted to send certain personal information to the resource process, namely: account number, mobile number, and account status.

After receiving approval from a device-end to continue responding to the request for additional resources (operation 715), the aggregated assistant prompts for the amount of resources that are being requested (operation 720). At 725, the number “25” is received. At operation 730, the aggregated assistant asks for additional information, noting that the number of requested resources has to be in one of several formats to be detected, and the assistant provides examples. At 735, the amount 25 Gb and an email id are received. At 740, the aggregated assistant indicates that the request is processed and accepted. There is a further prompt inviting an application for a monthly allocation in this amount, as the 25 Gb granted is a one-time acceptance. It is to be understood that many other items can be provided by the aggregated assistant in addition to computer resources (e.g., goods or services).

FIG. 7B illustrates an example of the skills aggregation 700B used in the resource request operation of FIG. 7A, consistent with an illustrative embodiment. It is to be understood that the skills used by the aggregated assistant are similar to the skills discussed with reference to FIG. 3. The first planner attempt 750 (planner attempt 1) utilizing the slot skill fill 792 fails after receiving a resource request because additional information was needed. The second planner attempt 760 requests approval to send information to use information regarding account number, mobile number, and account status, as in operation 710 shown in FIG. 7A. The slot skill fill 792 and the resource skill 780 are used. The information regarding the account number, the mobile number, the account status and a valid id are stored in memory slots using the slot skill fill 792. However, the second planner attempt fails because, as shown in FIG. 7A, the requested resource “25” in operation 725 is not in an identifiable format, as shown in the output of operation 730 in FIG. 7A. Now referring again to FIG. 7B, in the third planner attempt 770 through the use of the DBQ skill 785, OCR skill 790, and resource skill 780, there is sufficient information to process a resource request, as shown by the output 740 in FIG. 7A.

### Example Process

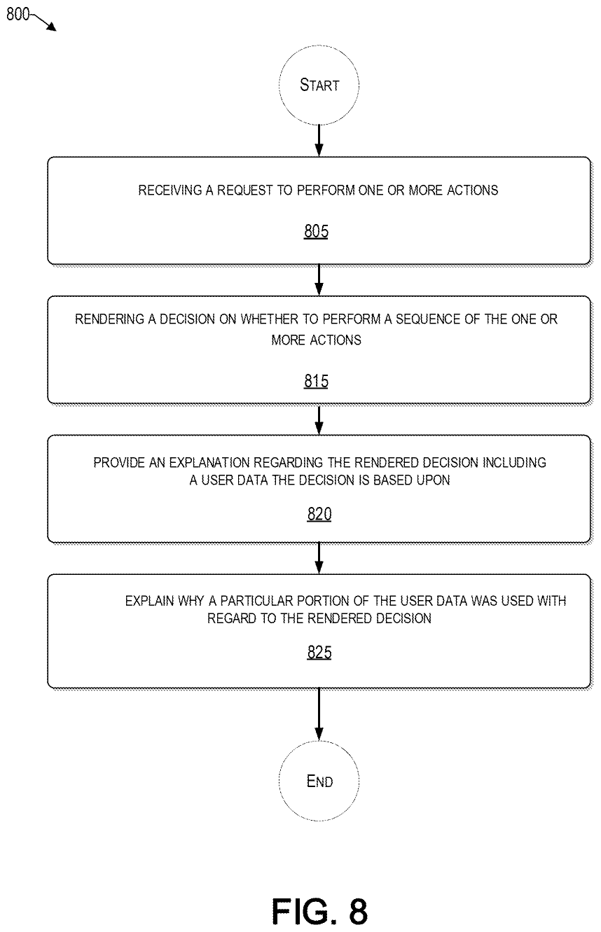

With the foregoing overview of the example architecture, it may be helpful now to consider a high-level discussion of an example process. To that end, FIG. 8 is a flowchart illustrating a computer-implemented method of generating explanations for actions of an aggregated assistant, consistent with an illustrative embodiment. FIG. 8 is shown as a collection of blocks, in a logical order, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At operation 805, a request is received to perform a sequence of actions. For example, a request for additional computer resources is received by the aggregated assistant such as shown in FIG. 7A. The request can be a text, utterance, email, motion, etc.

At operation 815, a decision is rendered on whether to perform the requested sequence of actions. For example, the aggregated assistant utilizes skills such as shown in FIG. 3 to verify the identity of a requestor, the account status, etc.

At operation 820, an explanation regarding the rendered decision including the user data the decision is based upon is provided. FIG. 1 shows at 110 an example explanation about the collected information.

At operation 825, an explanation is provided as why a particular portion of the user data was used with regard to the rendered decision. For example, in FIG. 1 at 140 there is an explanation as to why the information was used for an internal database query. The method for this illustrative embodiment ends at operation 825. However, in the case where the aggregated assistant receives landmarks drilled down by an end-user, additional responses would be generated.

### Example Particularly Configured Computer Hardware Platform

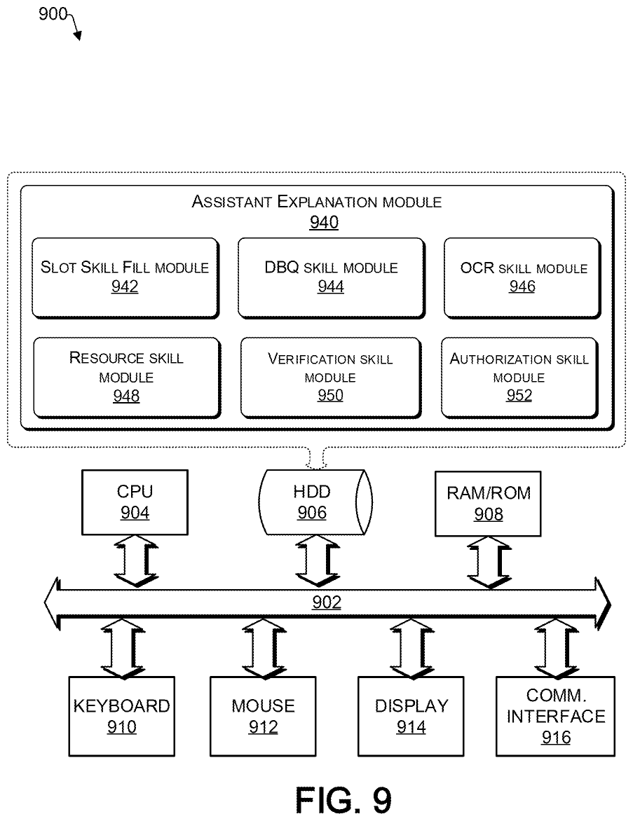

FIG. 9 provides a functional block diagram illustration 900 of a computer hardware platform. In particular, FIG. 9 illustrates a particularly configured network or host computer platform 900, as may be used to implement the method shown in FIG. 8.

The computer platform 900 may include a central processing unit (CPU) 904, a hard disk drive (HDD) 906, random access memory (RAM) and/or read-only memory (ROM) 908, a keyboard 910, a mouse 912, a display 914, and a communication interface 916, which are connected to a system bus 902. The HDD 906 can include data stores.

In one embodiment, the HDD 906 has capabilities that include storing a program that can execute various processes, such as machine learning.

In FIG. 9, there are various modules shown as discrete components for ease of explanation. However, it is to be understood that the functionality of such modules and the quantity of the modules may be fewer or greater than shown. It is to be understood that the modules shown and described herein can be trained by machine learning both to train and update their various operations.

The Assistant Explanation module 940 is configured to control the overall operation of the modules 942-952, consistent with an illustrative embodiment. For example, the assistant explanation module 940 is configured to orchestrate an aggregated assistant to produce goal-directed sequences of agents and skills from events. The module 940 is configured to convert an agent sequencing problem into a planning problem utilizing a model of how skills and agents operate. The skill or agent specification includes information for use by the assistant explanation module including: the function endpoint of the skill or agent; a user understandable description of what the skill or agent does to generate explanatory messages; an upper limit on a number of times the assistant can retry the same skill or agent to provide a desired outcome, and/or an approximate specification of functionality as a set of pairs of tuples of input and possible output pairs that represents the various operational modes of the skills.

The slot skill module 942 is configured to fill a generic slot or variable in a memory. Such slots may be filled by asking an end-user for certain information such as an account number, etc. The DBQ skill module 944 is configured to query a database to receive information. An OCR skill module 946 is configured to extract text from images as appropriate. A resource skill module 948 is configured to process requests for granting additional computer resources. Such resources can include but are not limited to additional memory, additional processing, and/or additional data usage on a network. The verification skill module 950 is configured to monitor an impact on a system if additional computer resources are provided to a requestor, and to verify a user's authenticity. The authorization skill module 952 model is configured to authorize the resource request, as discussed hereinabove.

### Example Cloud Platform

As discussed above, functions relating to the operation of an aggregated assistant may include a cloud. It is to be understood that although this disclosure includes a detailed description of cloud computing as discussed herein below, the implementation of the teachings recited herein is not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

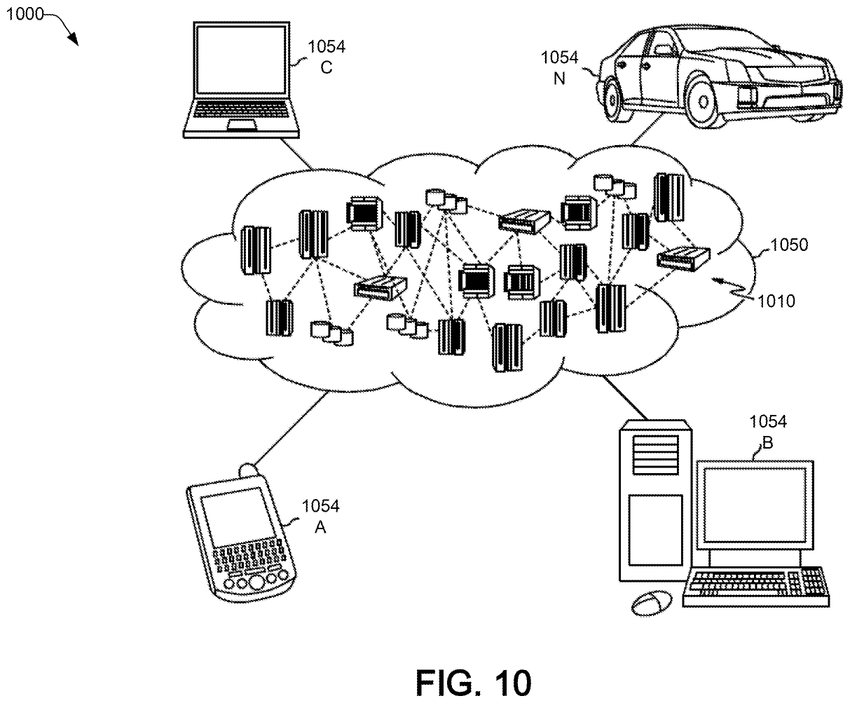

Referring now to FIG. 10, an illustrative cloud computing environment 1000 utilizing cloud computing is depicted. As shown, cloud computing environment 1000 includes cloud 1050 having one or more cloud computing nodes 1010 with which local computing devices are used by cloud consumers, such as, for example, personal digital assistant (PDA) or cellular telephone 1054A, desktop computer 1054B, laptop computer 1054C, and/or automobile computer system 1054N may communicate. Nodes 1010 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms, and/or software as services for which a cloud consumer does not need to maintain resources on a local computing device. It is understood that the types of computing devices 1054A-N shown in FIG. 10 are intended to be illustrative only and that computing nodes 1010 and cloud computing environment 1000 can communicate with any type of computerized device over any type of network and/or network addressable connection (e.g., using a web browser).

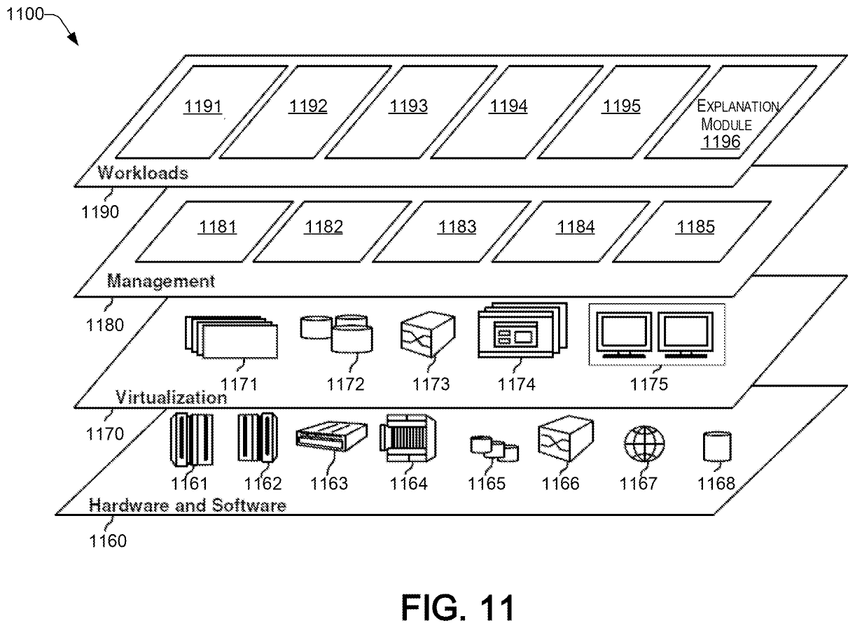

Referring now to FIG. 11, a set of functional abstraction layers 1100 provided by cloud computing environment 1000 (FIG. 10) is shown. It should be understood in advance that the components, layers, and functions shown in FIG. 11 are intended to be illustrative only and embodiments of the disclosure are not limited thereto. As depicted, the following layers and corresponding functions are provided:

Hardware and software layer 1160 include hardware and software components. Examples of hardware components include: mainframes 1161; RISC (Reduced Instruction Set Computer) architecture-based servers 1162; servers 1163; blade servers 1164; storage devices 1165; and networks and networking components 1166. In some embodiments, software components include network application server software 1167 and database software 1168.

Virtualization layer 1170 provides an abstraction layer from which the following examples of virtual entities may be provided: virtual servers 1171; virtual storage 1172; virtual networks 1173, including virtual private networks; virtual applications and operating systems 1174; and virtual clients 1175.

In one example, management layer 1180 may provide the functions described below. Resource provisioning 1181 provides dynamic procurement of computing resources and other resources that are utilized to perform tasks within the cloud computing environment. Metering and Pricing 1182 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1183 provides access to the cloud computing environment for consumers and system administrators. Service level management 1184 provides cloud computing resource allocation and management such that required service levels are met. Service Level Agreement (SLA) planning and fulfillment 1185 provide pre-arrangement for, and procurement of, cloud computing resources for which a future requirement is anticipated in accordance with an SLA.

Workloads layer 1190 provides examples of functionality for which the cloud computing environment may be utilized. Examples of workloads and functions which may be provided from this layer include: mapping and navigation 1191; software development and lifecycle management 1192; virtual classroom education delivery 1193; data analytics processing 1194; transaction processing 1195; and an explanation module 1196 configured to operate as part of an aggregated assistant, as discussed herein above.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

The flowchart, and diagrams in the figures herein illustrate the architecture, functionality, and operation of possible implementations according to various embodiments of the present disclosure.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method of generating explanations for actions of an automated assistant, the method comprising:
receiving a request from a user equipment (UE) to execute a sequence of actions;
rendering a decision on whether to execute the requested sequence of actions; and
outputting to the UE an explanation about the rendered decision to execute the sequence of actions including an identification of user data upon which the rendered decision is based.

2. The computer-implemented method of claim 1, further comprising reducing a computational burden on the automated assistant by outputting the identification of the user data without receiving a request from the UE for the identification of the user data; and
wherein the explanation includes information about why a particular portion of the user data was used to render the decision to execute the sequence of actions.

3. The computer-implemented method of claim 1, wherein the explanation includes information about how a particular portion of the user data was used to render the decision to execute the sequence of actions, including whether the user data was shared with another entity.

4. The computer-implemented method of claim 1, further comprising:
requesting confirmation to share at least a portion of the user data with another entity to render the decision to executing the sequence of actions, and
wherein the explanation includes information about how a particular portion of the user data is going to be used with the other entity to render the decision to execute the sequence of actions, and why a particular portion of the user data is going to be used to render the decision to execute the sequence of actions.

5. The computer-implemented method of claim 1, wherein the automated assistant comprises an aggregated assistant including a plurality of skills and one or more agents, the method further comprising:
receiving a query for a provenance of the user data to render the decision to executed the sequence of actions; and
generating a summary explanation about the provenance of the user data used to render the decision to execute the sequence of actions.

6. The computer-implemented method of claim 5, further comprising generating the summary explanation about the provenance of the data by using an explainability model, and
augmenting the provenance of the user data and an explanation of part of the user data executed by each action of the sequence of actions.

7. The computer-implemented method of claim 5, wherein the summary explanation is configured as a summary of landmarks to be drilled down recursively.

8. The computer-implemented method of claim 5, wherein in response to the received query for provenance, the summary explanation includes a reason why a particular portion of the user data was examined to render the decision to execute the sequence of actions.

9. The computer-implemented method of claim 5, wherein in response to the received query for provenance, the summary explanation includes information indicating how a particular portion of user data was used to render the decision to execute the sequence of actions.

10. The computer-implemented method of claim 5, wherein in response to the received query for provenance, the summary explanation includes an identification of any other entities with which the user data is going to be shared, and wherein the explanation includes information about how a particular portion of the user data is going to be used with the other entity to render the decision to execute the sequence of actions, and why a particular portion of the user data is going to be used to render the decision to execute the sequence of actions.

11. The computer-implemented method of claim 5, wherein the aggregated assistant is configured to be debugged based on sample compositions.

12. The computer-implemented method of claim 5, further comprising:
generating decision elements by one or more of the plurality of skills or agents; and
including one or more explanations of the decision elements automatically.

13. A computing device configured for generating an explanation for actions of an aggregated assistant, the computing device comprising:
a processor;
a memory coupled to the processor, the memory storing instructions to cause the processor to perform acts comprising:
receiving a request to perform a sequence of actions;
rendering a decision on whether to perform the requested sequence of actions; and
providing an explanation to render the decision to perform the sequence of actions including a user data upon which the rendered decision is based.

14. The computing device of claim 13, wherein the instructions cause the processor to perform additional acts comprising:
receiving a query for a provenance of the user data to render the decision to perform the sequence of actions;
generating a summary explanation about the provenance of the user data used to render the decision to perform the sequence of actions.

15. The computing device of claim 13, wherein the instructions cause the processor to perform additional acts comprising reducing the computational burden of the processor by generating the summary explanation about the provenance of the user data used to render the decision without receiving a request regarding the provenance of the user data; and
using an explainability model to generate the summary explanation.

16. The computing device of claim 13, wherein the instructions cause the processor to perform an additional act comprising generating the summary explanation about the provenance of the user data used to render the decision to perform the action as a summary of landmarks configured to be drilled down recursively.

17. The computing device of claim 13, wherein the instructions cause the processor to perform an additional act comprising requesting a confirmation to share at least a portion of the user data with another entity to render the decision to perform the sequence of actions, and wherein the summary explanation includes information about how a particular portion of the user data is going to be used with the other entity to render the decision to perform the sequence of actions, and why a particular portion of the user data is going to be used to render the decision to perform the sequence of actions.

18. The computing device of claim 13, wherein the instructions cause the processor to perform an additional act comprising explaining why a particular portion of the user data was used to render the decision to perform the sequence of actions.

19. The computing device of claim 13, wherein the instructions cause the processor to perform additional acts comprising:
generating decision elements by one or more of the plurality of skills or agents; and
including one or more explanations of the decision elements automatically.

20. A non-transitory computer-readable storage medium tangibly embodying a computer-readable program code having computer-readable instructions that, when executed, causes a computer device to perform a method of generating explanations for actions of an aggregated assistant, the method comprising:
receiving a request to perform a sequence of actions;
rendering a decision on whether to perform the requested sequence of actions; and
providing an explanation regarding the rendered decision to perform the sequence of actions that identifies a user data upon which the rendered decision is based.
